(19) United States
(12) Patent Application Publication
(10) Pub. No.: US 2007/0052624 A1
(43) Pub. Date: Mar. 8, 2007

(54) PLASMA DISPLAY PANEL AND DRIVING METHOD THEREOF

(75) Inventors: Yoonyoung CHOI, Gyeonggi-do (KR); Bumjoo LEE, Seoul (KR); Kyung Wha LEE, Seoul (KR); Chung Jae SANG, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/470,889

(22) Filed: Sep. 7, 2006

(30) Foreign Application Priority Data
Sep. 7, 2005 (KR) 10-2005-0083274

(51) Int. Cl. G09G 3/28

(52) U.S. Cl. 345/67

(57) ABSTRACT

Provided are a plasma display panel and a driving method thereof. The plasma display panel comprises a first display electrode provided in a front substrate, a second display electrode provided in a direction intersecting with the first display electrode in a rear substrate, and an address electrode provided in parallel with the second display electrode in the rear substrate.

This Nonprovisional application claims priority under 35 U.S.C. § 119(a) on Patent Application No. 10-2005-0083274 filed in Korea on Sep. 7, 2005 the entire contents of which are hereby incorporated by reference.

### BACKGROUND

1. Field

The present invention relates to a plasma display panel and a driving method thereof.

2. Description of the Background Art

In general, a plasma display panel comprises a phosphor layer within a discharge cell partitioned by a barrier rib, and comprises a plurality of electrodes to apply a driving signal to the discharge cell.

In the plasma display panel, when the driving signal is applied to the discharge cell, a discharge gas filled in the discharge cell generates vacuum ultraviolet rays. The vacuum ultraviolet rays excite phosphors provided within the discharge cell, thereby embodying an image.

### SUMMARY

Accordingly, an object of the present invention is to provide a plasma display panel and a driving method thereof, for improving an efficiency of light emission and a luminance characteristic.

In one aspect, there is provided a plasma display panel. The plasma display panel comprises a first display electrode provided in a front substrate, a second display electrode provided in a direction intersecting with the first display electrode in a rear substrate, and an address electrode provided in parallel with the second display electrode in the rear substrate.

Implementations may include one or more of the following features. For example, the address electrode is provided in parallel at both sides of the second display electrode within one discharge cell.

The transparent electrode of the first display electrode comprises a protrusion within one discharge cell.

In another aspect, there is provided a method for driving a plasma display panel by applying a driving pulse to an electrode of the plasma display panel that comprises a front substrate comprising a first display electrode, a rear substrate comprising a second display electrode in a direction intersecting with the first display electrode, and two address electrodes provided in parallel at both sides of the second display electrode within one discharge cell formed by an intersection of the first and second display electrodes. The driving method comprises applying a reset pulse to the second display electrode in a reset period; in an address period, applying a scan pulse to the first display electrode, and concurrently applying data pulses to the address electrodes, respectively; and applying a sustain pulse alternately to the first and second display electrodes in a sustain period.

Implementations may include one or more of the following features. For example, the data pulse applied to the address electrode has a reference potential of ground or less.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a perspective view illustrating a plasma display panel according to an exemplary embodiment of the present invention;

FIGS. 2A to 2D illustrate several examples of electrode shape and arrangement structure in a discharge cell of a plasma display panel according to an exemplary embodiment of the present invention;

FIG. 3 illustrates a driving method of a plasma display panel according to an exemplary embodiment of the present invention;

FIG. 4 illustrates a construction of a plasma display panel according to another exemplary embodiment of the present invention; and

FIG. 5 illustrates a driving method of the plasma display panel shown in FIG. 4.

### DETAILED DESCRIPTION OF PREFERRED EMBODIMENTS

Preferred embodiments of the present invention will be described in a more detailed manner with reference to the drawings.

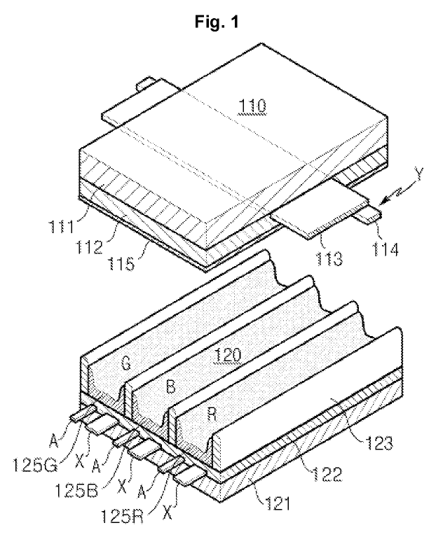

FIG. 1 is a perspective view illustrating a plasma display panel according to an exemplary embodiment of the present invention.

Referring to FIG. 1, the plasma display panel comprises a front panel 110, and a rear panel 120 positioned in parallel with the front panel 110.

The front panel 110 comprises a first display electrode (Y) arranged in parallel on a front substrate 111. The rear panel 120 comprises an address electrode (A) and a second display electrode (X) arranged vertically with the first display electrode (Y) on a rear substrate 121.

In the front panel 110 and the rear panel 120, a plurality of the first display electrodes and a plurality of the address electrodes and the second display electrodes are arranged in row and column.

The first display electrode (Y) can be provided as only a single layered bus electrode. However, as shown, the first display electrode (Y) comprises a conductive layer 113 formed of a transparent electrode material such as indium tin oxide (ITO), and a bus electrode 114 formed of a conductive metal, such as chrome (Cr) or silver (Ag), along an edge of the transparent conductive layer 113 to complement a high resistance of the transparent conductive layer 113.

The first display electrode (Y) is a scanning electrode for displaying an image on the front panel 110 when the plasma display panel is driven.

A dielectric layer 112 formed of a low melting point glass having a thickness of about 30 μm is coated on the first display electrode (Y). A protective layer 115 such as oxide magnesium is deposited on the dielectric layer 112.

Like the first display electrode (Y), the second display electrode (X) of the rear substrate can comprise a transparent electrode and a bus electrode, but as shown, is provided as a single layered bus electrode. The address electrode (A) is also provided as a single layered bus electrode.

A dielectric layer 122 is coated at a thickness of about 10 μm on the address electrode (A) and the second display electrode (X). A barrier rib 123 having a height of about 150 μm is arranged on the dielectric layer 122 in a direction parallel with the second display electrode (X) and the address electrode (A).

The barrier rib 123 forms a discharge space.

A structure of a discharge cell formed by the barrier rib is not limited to a stripe structure. The discharge cell structure can be of other structures capable of housing the above electrode arrangement, for example, a waffle structure or a meander structure.

Red, Green, and Blue phosphor layers 125R, 125G, and 125B are formed on the dielectric layer 122 and the barrier rib 123, respectively. The phosphor layers 125R, 125G, and 125B can be also provided only on the barrier rib 123. Unlike this, an additional protective layer (not shown) can be also provided on the phosphor layers 125R, 125G, and 125B to protect the phosphor layers 125R, 125G, and 125B from collision with charged particles.

A discharge gas for plasma discharge is filled in the discharge space between the front panel 110 and the rear panel 120. A unitary pixel formed by the barrier rib is divided into Red, Green, Blue subpixels.

The plasma display panel is driven using a driver for, though not shown, driving each electrode.

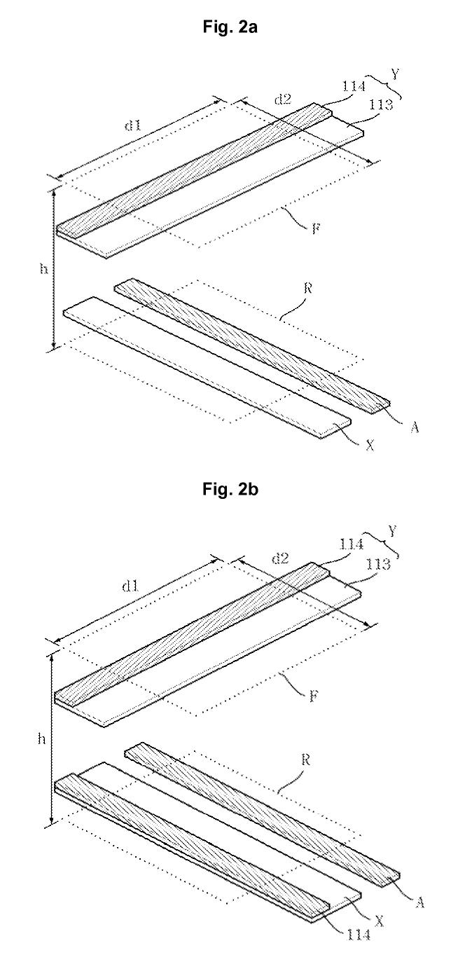

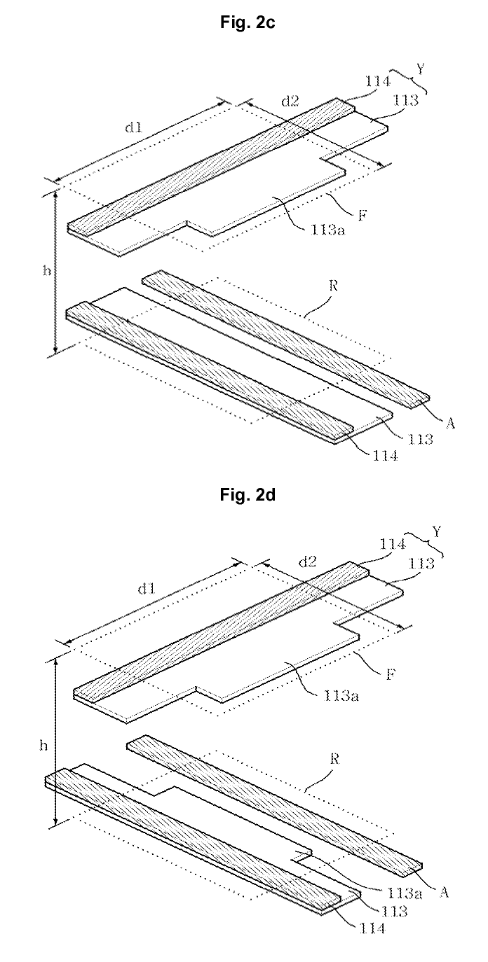

FIGS. 2A to 2D illustrate several examples of electrode shape and arrangement structure in the discharge cell of the plasma display panel according to an exemplary embodiment of the present invention.

Referring to FIGS. 2A to 2D, in the plasma display panel, the first display electrode (X), and the second display electrode (Y) and the address electrode (A) are arranged on two substrates (F, R) that are spaced a predetermined interval (h) apart from each other. The two substrates (F, R) can be defined as planes each having horizontal and vertical lengths of “d1” and “d2”. The planes are based on a two-dimensional standard of the discharge cell constituting the plasma display panel (PDP). The lengths (d1 and d2) of each substrate can be designed on the basis of a PDP cell size.

The first display electrode (Y) is provided on one plane (F), and the second display electrode (X) and the address electrode (A) are provided on the other plane (R).

The second display electrode (X) and the address electrode (A) may not be disposed on the same plane.

The first display electrode (Y) comprises the transparent electrode 113, and the bus electrode 114 that is a metal electrode. As shown in FIGS. 2C and 2D, the transparent electrode 113 can comprise a protrusion 113a within one discharge cell. When the plasma display panel is driven, the protrusion 113a can enlarge a discharge area, thereby improving an efficiency of discharge.

The second display electrode (X) can comprise only a metal electrode. Alternately, the second display electrode (X) can comprise a transparent electrode and the metal electrode. The transparent electrode can comprise a protrusion 113a within one discharge cell as shown in FIG. 2D.

Widths of the transparent electrodes of the first display electrode (Y) and the second display electrode (X) can be kept constant in a whole of the plasma display panel. However, the widths of the transparent electrodes can be differentiated depending on a kind of the phosphor provided within the discharge cell.

The address electrode (A) and the second display electrode (X) are spaced a predetermined distance (w1) apart from each other. The spaced distance is about 50 μm or less.

A distance between the first display electrode (Y) and the second display electrode (X) is provided greater than at least a height of the barrier rib so that, when the plasma display panel is driven, the plasma discharge can be induced using a positive column. Preferably, the distance ranges from about 100 μm to 500 μm.

The plasma display panel having the electrode shape and electrode arrangement structure can improve the discharge efficiency at the time of the plasma discharge.

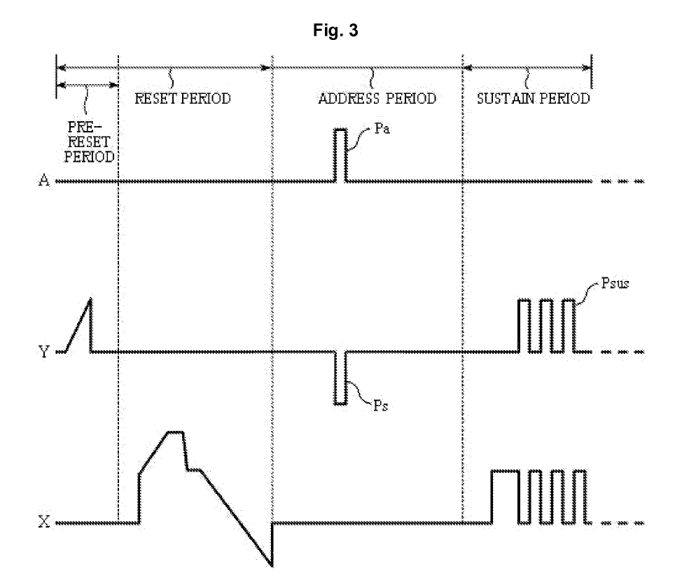

FIG. 3 illustrates a driving method of the plasma display panel according to an exemplary embodiment of the present invention.

As shown in FIG. 3, in the driving method of the plasma display panel, a positive address pulse (Pa) applied to the address electrode (A) and a negative scan pulse (Ps) applied to the first display electrode (Y) in an address period induce the discharge, thereby selecting the cell.

In the selected cell, an address discharge is induced between the first display electrode (Y) and the address electrode (A) and thus, negative charges are accumulated on the address electrode (A) and positive charges are accumulated on the first display electrode (Y).

Not illustrated in the drawings, but reference potentials of two electrodes can be differentiated from each other to facilitate formation of a wall voltage when an opposed discharge is induced between the first display electrode (Y) and the address electrode (A) in the address period.

Next, in a sustain period, a sustain pulse (Psus) having a lower voltage than a discharge voltage is applied alternately between the second display electrode (X) and the first display electrode (Y). Thus, the discharge is sustained in the cell selected in the address period.

In a reset period, a state of a wall voltage within a pixel where a sustain discharge has been induced in an earlier sustain period equals to a state of a wall charge of an off cell. For example, at a time point when the sustain discharge ends, a pre-reset pulse can be applied to the first display electrode (Y) and then, a reset operation can be performed in such a manner that a ramp waveform is applied to the second display electrode (X).

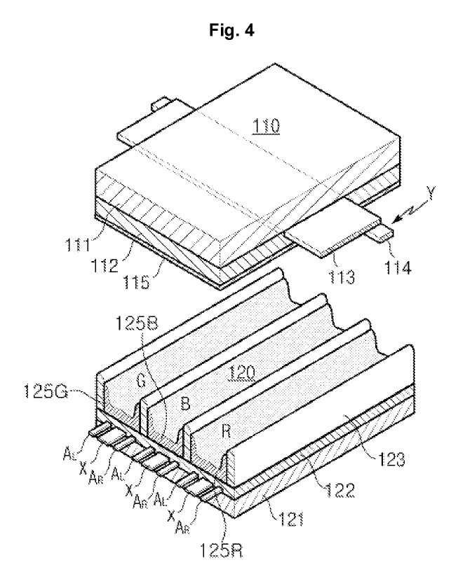

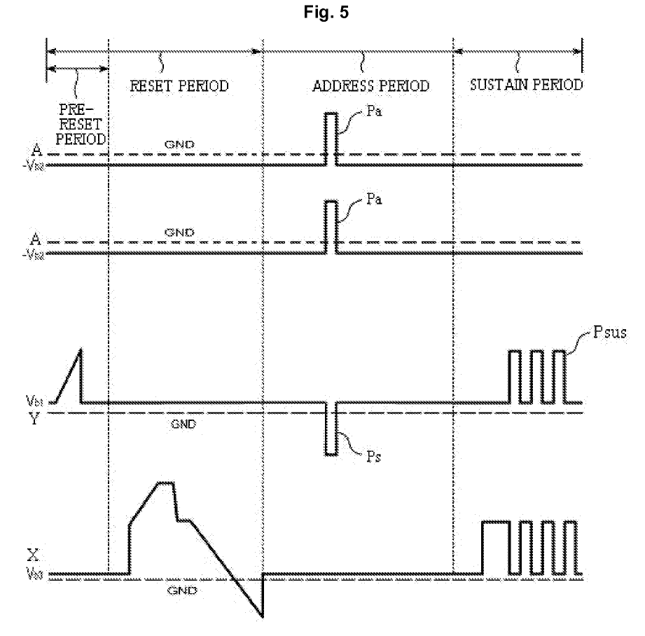

FIG. 4 illustrates a construction of a plasma display panel according to another exemplary embodiment of the present invention.

Referring to FIG. 4, the construction of the plasma display panel is almost the same as the construction of the plasma display panel shown in FIG. 1. However, address electrodes (A_{L}, A_{R}) provided in a rear substrate 121 are provided in parallel at both sides of a second display electrode (X) within one discharge cell.

In the above construction, a reset discharge can be more smoothly induced between the second display electrode (X) and the address electrodes (A_{L}, A_{R}), thereby making wall charges uniform within the discharge cell.

Electrode shape and arrangement structure can be also provided identically with the examples shown in FIGS. 2A to 2D.

FIG. 5 illustrates a driving method of the plasma display panel shown in FIG. 4.

Referring to FIG. 5, the driving method is almost the same as the driving method of the plasma display panel of FIG. 3. However, a driving pulse, for example, a scan pulse applied to the first display electrode (Y) has a reference potential of positive voltage (V_{b1}). A data pulse applied to the address electrode (A) has a reference potential of ground (GND) or less. In other words, the data pulse has a reference potential of negative voltage (−V_{b2}).

A driving pulse applied to the second display electrode (X) can have a reference potential of a bias voltage (V_{b3}) lower than the positive voltage (V_{b1}) applied to the first display electrode (Y).

The driving pulse applied to the second display electrode (X) has a reference potential of positive voltage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a first display electrode provided in a front substrate;
a second display electrode provided in a direction intersecting with the first display electrode in a rear substrate; and
an address electrode provided in parallel with the second display electrode in the rear substrate.

2. The plasma display panel of claim 1, wherein the address electrode is provided in parallel at both sides of the second display electrode within one discharge cell.

3. The plasma display panel of claim 1, wherein an interval between the first and second display electrodes ranges from about 100 μm to 500 μm.

4. The plasma display panel of claim 1, wherein the first display electrode comprises a transparent electrode and a bus electrode.

5. The plasma display panel of claim 1, wherein each of the second display electrode and the address electrode is provided as a single layer.

6. The plasma display panel of claim 5, wherein each of the second display electrode and the address electrode is provided as only a metal electrode.

7. The plasma display panel of claim 1, wherein the first display electrode is an electrode for scanning.

8. The plasma display panel of claim 4, wherein the transparent electrode of the first display electrode comprises a protrusion within one discharge cell.

9. The plasma display panel of claim 1, wherein the second display electrode comprises a transparent electrode and a bus electrode, and
the transparent electrode of the second display electrode comprises a protrusion within one discharge cell.

10. A method for driving a plasma display panel by applying a driving pulse to an electrode of the plasma display panel that comprises a front substrate comprising a first display electrode, a rear substrate comprising a second display electrode in a direction intersecting with the first display electrode, and two address electrodes provided in parallel at both sides of the second display electrode within one discharge cell formed by an intersection of the first and second display electrodes, the method comprising steps of:
applying a reset pulse to the second display electrode in a reset period;
in an address period, applying a scan pulse to the first display electrode, and concurrently applying data pulses to the address electrodes, respectively; and
applying a sustain pulse alternately to the first and second display electrodes in a sustain period.

11. The driving method of claim 10, wherein a reset discharge is induced between the second display electrode and the address electrode.

12. The driving method of claim 10, wherein an address discharge is induced between the first display electrode and the address electrode.

13. The driving method of claim 10, wherein a sustain discharge is induced between the first display electrode and the second display electrode.

14. The driving method of claim 10, wherein the data pulse applied to the address electrode has a reference potential of ground or less.

15. The driving method of claim 10, wherein a driving pulse applied to the first display electrode has a reference potential of positive voltage.

16. The driving method of claim 10, wherein a driving pulse applied to the second display electrode has a lower reference potential than a driving pulse applied to the first display electrode.

17. The driving method of claim 16, wherein the driving pulse applied to the second display electrode has the reference potential of positive voltage.
